(19) United States
(12) Patent Application Publication
(10) Pub. No.: US 2023/0335365 A1
(43) Pub. Date: Oct. 19, 2023

(54) ELECTRON SOURCE AND PATTERN MODULATOR

(71) Applicant: John Bennett, Sammamish, WA (US)

(72) Inventor: John Bennett, Sammamish, WA (US)

(21) Appl. No.: 17/720,221

(22) Filed: Apr. 13, 2022

(51) Int. Cl. H01J 29/96; H01J 29/46

(52) U.S. Cl. CPC H01J 29/96; H01J 29/46

(57) ABSTRACT

Systems and methods are described herein for generating, modulating, and/or shaping a plurality of electron beams to be used in various lithography processes. In some aspects, multiple beams may be individually modulated to create a pattern which is projected onto a surface proximate to the source of the electrons. In other aspects, the multiple beams may be projected at a distance through a lensing system. Targets for the electron patterns include surfaces which react with the electrons to undergo chemical or structural change. In some aspects, a parallel electron multi-beam source is constructed using edge emitters formed where etching, cleaving, or other processes have created a surface perpendicular to the edge of one conductor which is adjacent to a thin insulator which separates it from a second conductor.

### BACKGROUND

Lithography is a technology for the creation of patterns on the surface of materials. It begins with covering a target surface with a material layer known as a “resist”. The resist will be transformed by a patterned exposure to energy such as visible light, ultra-violet, or electrons, which make a chemical or structural transformation of the resist following the exposure pattern. This change is exploited chemically or physically to enable the underlying object to be differently processed according to the pattern of the changes in the resist. Lithography based on such exposure and processing has become the basic technology in forming modern integrated circuitry as well as other nanometer scale devices including pattern masks, accelerometers, chemical processing devices, surface textures and images, gyroscopes, antennas, micromirrors, and other micro electro-mechanical systems (MEMS).

Lithography typically uses light as the exposure mechanism but electron beams also can deliver energy for chemical or physical changes in resists. Electrons can expose patterns with focus sharpness on the order of 1 nm or less. However, electron beams over long distances of centimeters or more can expose areas only slowly since the electrons repel each other if the beam is intense. The practical rate at which an area can be exposed by single beams is too small for volume production. The data rate may be increased by operating multiple beams in parallel, but at centimeter scale and above, the number of such beams has been limited and the speedups have not been sufficient for practical rates of production. Current use of electron beam lithography is typically only for specialized applications such as prototyping or mask production where exposure times of many hours are acceptable. Further, electron beam sources can be vulnerable to contamination from the target, which may rapidly spoil a source which is exposed to that contamination. Short distances (sub-centimeter) from source to target have been impractical for that reason. Downtime for planned and unplanned maintenance present serious problems in electron lithography as well.

### BRIEF DESCRIPTION OF THE DRAWINGS

Various techniques will be described with reference to the drawings, in which:

FIG. 1 illustrates an example circuit schematic for electronic control of a single electron beam source using the Fowler-Nordheim effect to emit electrons through the side wall of a well etched into a conductor under a dielectric, in accordance with at least one embodiment;

FIGS. 2-17 illustrate example process steps for constructing the circuit of FIG. 1, using a Complementary Metal Oxide Silicon (CMOS) planar process, in accordance with at least one embodiment;

FIG. 18 illustrates an example circuit schematic for multiple beam sources including control lines for selection, strobes, and pattern data, in accordance with at least one embodiment;

FIG. 19 illustrates in cutaway view of an unfocused projector which uses a final aperture to shape the exit beam which will illuminate a target in proximity to the exit, in accordance with at least one embodiment;

FIG. 20 illustrates an example view of a cell of an unfocused projector, such as the example illustrated in FIG. 19, in accordance with at least one embodiment;

FIG. 21 illustrates an example of multiple cells constructed adjacently to provide an array of electron emission units with connected control circuits, in accordance with at least one embodiment; and

FIG. 22 illustrates a set of adjacent proximity projection cells as seen from the side where the beams exit, with the exit apertures aligned to form an array of shaped beams in accordance with at least one embodiment.

### DETAILED DESCRIPTION

The systems and methods described herein build upon the highly parallel MEMS construction of millions of columns of electron optics by replacing the photocathode with an alternative electron beam array source. This novel array source can be fabricated with millions of beams at micron scale which directly couple into the focusing beam columns. These sources may be modulated with simple, low voltage electronics with nanosecond-scale switching times.

In some aspects, a Complementary Metal Oxide Silicon (CMOS) array device is used to modulate the beam currents. The sources have been observed to be remarkably resistant to contamination, undamaged by operation in air for example, though they may also be constructed to incorporate an electron transparent pellicle for extended stable operation. Finally, the source array may be built inexpensive enough to be discarded and replaced on a regular schedule or if unexpected contamination or failures are discovered.

This source couples through shaped apertures at the entrance to the electron optic columns to provide controlled patterns of pulsed electrons onto the target at the output focus of the columns. This source can provide beam current modulated at tens of millions of pulses per second per beam. With millions of beams the array can expose trillions of pixels per second upon the target wafer, each pixel being a clearly formed shape such as a rectangle or a circle.

In some cases, each pulse will deliver tens of thousands of electrons to shapes which are the image of the aperture focused upon the target. This will be upwards of 100 electrons per square nanometer so that the statistical variation will be minimal and smooth edges will be feasible at the nanometer resolution level. The electron optics, at micron distance from their targets, can have numerical apertures exceeding 0.10 which yields a resolution of around 1 nm at 50 volts. This is 10×more precise than EUV.

This device, referred to as a Beam Generation Assembly (BGA), may be a small MEMS/CMOS device housed within a machine which supplies power, pattern data, and timing, while moving a target in a transverse scanning operation across the beams' focal plane, while using alignment technologies around the BGA to measure the wafer location relative to the BGA for accurate pattern registration. Such machines are expected to be compact, cost effective, and suitable for numerous machines to be deployed within a single production line for high overall throughput and the flexibility to adapt to different designs with short lead times.

In a related application, U.S. patent application Ser. No. 16/859,257, filed Apr. 27, 2020, entitled “MODULAR PARALLEL ELECTRON LITHOGRAPHY,” the contents of which are hereby incorporated in their entirety, the use of photocathodes as electron sources coupled to highly parallel micron scale focusing beam columns constructed with MEMS technology was disclosed. That approach greatly increased throughput, while the issues of eventual contamination were circumvented by disposal and replacement of the entire MEMS assembly at acceptable cost and minimum downtime. The techniques described herein utilize the focusing beam columns with a different electron source to provide various benefits and advantages, as will be described in greater detail below.

In one aspect. an electron emitter array may include a plurality of electron emitters. Individual electron emitters may include a first conductor having a conductor edge, an insulator adjacent to the first conductor, and a second conductor adjacent to the insulator. The first conductor, the insulator, and the second conductor may form a channel such that an electric field from the second conductor at the opposite side of the insulator from the first conductor attracts electrons to form an electron beam via Fowler-Nordheim electron emission directed away from the conductor edge of the first conductor through the channel past the second conductor into a vacuum chamber beyond the second conductor. The electron emitter array may further include control circuity in communication with individual electron of the plurality of electron emitters. In some cases, the plurality of electron emitters may be formed on the control circuity. The control circuitry may direct voltages to be applied across individual insulators of individual electron emitters so an electric gradient may be applied, thus activating the individual electron emitters to form a pattern beyond the vacuum chamber, wherein, upon exposure to a target, the pattern is formed on the target.

In some cases, the electron emitter array may also include a conductor plane spaced apart from the second conductor and forming a plurality of apertures aligned with channels of the individual electron emitters, where individual apertures of the plurality of apertures form shapes that modify the pattern. In some cases, the conductor plane has a positive voltage relative to the second conductor. In yet some cases, a size of the individual apertures is smaller than beams formed from individual channels of individual electron emitters of the plurality of electron emitters. In some examples, the electron emitter array may additionally or alternatively include an array of electron-optic channels aligned with individual apertures of the plurality of apertures of the conductor plane, where as voltage is applied to the array of electron-optic channels, electrons are accelerated through the array of electron-optic channels to form the pattern on the target.

In some cases, the electron emitter array may additionally or alternatively include an electron-transparent pellicle proximate to the second conductor of individual electron emitters of the plurality of electron emitters that allows electrons to pass while isolating the of individual electron emitters from molecular contamination. In other cases, the electron-transparent pellicle may be proximate to the conductor plane, where it allows electrons to pass while isolating the individual electron emitters from molecular contamination. In this example, the electron-transparent pellicle may flatten the electron gradient proximate to individual apertures of the plurality of apertures to reduce lensing effects. In some cases, the electron emitter array may additionally or alternatively include at least one shaped surface surrounding individual apertures of the plurality of apertures designed to flatten the electric gradients at the entry and exit from the individual apertures to minimize lensing effects.

In some cases, the control circuity may include one or more complementary metal oxide silicon (CMOS) devices, including a plurality of transistors each operating as a latch for individual electron emitters of the plurality of electron emitters. Upon application of a first signal, a value may be stored in individual transistors of the plurality of transistors. Upon application of a second signal, the value from the induvial transistors may be used to form a pattern on the target. In some cases, the first signal may include a signal applied through a bit select line or an inverse bit select line communicatively coupled with an individual transistor of the plurality of transistors. In this example, the second signal may be applied simultaneously to the plurality of electron emitters to form the pattern.

In some cases, at least a subset of the plurality of electron emitters terminate within the electron emitter array, such that when the subset of electron emitters are activated in conjunction with other electron emitters of the plurality of electron emitters, they provide substantially unform heating across the electron emitter array.

In another aspect, an electron emitter array may include a plurality of electron emitters, where individual electron emitters of the plurality of electron emitters include a voltage source, a conductor plane in communication with the voltage source, and an insulator proximate to the conductor plane. In this example, the conductor plane and the insulator form a well having a wall, such that when the voltage source is activated, an electric field gradient is formed on the wall and produces a flow of electrons out of the well. The electron emitter array may further include an array of electron-optic channels, where individual electron-optic channels of the array of electron-optic channels are positioned on and aligned with individual electron emitters of the plurality of electron emitters such that the flow of electrons is directed through the individual electron-optic channels due to a net positive potential gradient from the well towards the individual electron-optic channels through a cavity forming free space between the individual insulators and the array of electron-optic channels to form a pattern proximate to an exit of the array of electron-optic channels.

In some cases, the plurality of electron emitters are formed on a substrate, and the electron emitter array further includes control circuitry on or proximate to the substrate, where the control circuitry is configured to apply a voltage to individual wells of the individual electron emitters such that the electric field gradient on the wall may be varied to affect a rate of the flow of electrons out of the well. In some examples, the control circuitry may additionally or alternatively include at least one memory bit per individual electron emitter and a strobe line communicatively connected to the at least one memory bit of each of the plurality of electron emitters. When a strobe signal is applied to the strobe line, the plurality of electron emitters may form the pattern according to the at least one memory bit in each of the plurality of electron emitters.

In some cases, the electron emitter array may additionally or alternatively include a second conductor plane forming a number of perforations aligned with individual electron emitters of the plurality of electron emitters, where the number of perforations define the pattern that is formed proximate to the exit of the array of electron-optic channels. In some cases, individual perforations of the number of the perforations may include an aperture defining an opening comprising one of a circle, square, or square with rounded corners. In some aspects, the electron emitter array may additionally or alternatively include at least one varied surface shape around each aperture designed to flatten the electric gradient at an entrance and exit of the aperture so as to reduce blur in imaging the aperture by the electron-optical channel.

In some aspects, the electron emitter array may additionally or alternatively include a second memory system communicatively coupled to the control circuitry, wherein the second memory system is accessed via the strobe line to increase the rate of pattern generation of the electron emitter array. In some aspects, at least a subset of the plurality of electron emitters terminate within the electron emitter array. When the subset of electron emitters are activated in conjunction with other electron emitters of the plurality of electron emitters, substantially unform heating may be provided across at least a portion of the electron emitter array.

Systems and methods are described herein for generating, modulating, and shaping a plurality of electron beams each with nanometer-scale beam focus, to be used in various lithography processes. The described systems and techniques enable high throughput through parallel operation with minimal interference between beams. Such sources of controlled, precise multiple beams may have various uses. In some aspects, multiple beams may be individually modulated to create a pattern which is projected onto a surface proximate to the source of the electrons. In other aspects, the multiple beams may be projected at a distance through a lensing system. Targets for the electron patterns include surfaces which react with the electrons to undergo chemical or structural change. Such surfaces may incorporate physical or chemical “resists” designed to be further processed to convert the changed resists into surface masks used to control further processing of a material below the resist. In other cases, the electron bombardment may produce a durable change in the target surface which is the direct final patterned product.

In some aspects, a parallel electron multi-beam source is constructed using edge emitters formed where etching, cleaving, or other processes have created a surface perpendicular to the edge of one conductor which is adjacent to a thin insulator which separates it from a second conductor. When the conductors are each of appropriate metals having properties such as work function paring (the energy needed to remove electrons from inside the conductor out to vacuum), and where the second conductor is more positive than the first conductor, the combination of energy bands and the presence of a crowd of electrons on the surface of the first conductor where they are attracted to the second conductor, creates the conditions for electrons to flow out of the first conductor into the free space at the edge. In this arrangement, the first conductor may be referred to as the cathode, and the second conductor may be referred to as either an anode or a gate electrode, depending upon the presence of other elements. When other electric potentials are arranged to be more positive than these conductors, the freed electrons can be accelerated away to form a source of free electrons moving under paths controlled by the other electric potentials. The availability of those electrons is modulated by the difference between the first and second conductors, as that difference across the thin insulator determines the amount of charge crowded into the conductor surfaces and the propensity of the electron crowd on the first conductor to cause electrons to flow from the edge.

The described devices may operate in a low pressure or vacuum, where the mean free path of the gas is substantially longer than the distance from cathode to anode of the electron flow, so that free ballistic electrons dominate the effects and very few ionized particles are induced. The mean free path of air at atmospheric pressure is 50 nanometers, and it is proposed herein to have a mean free path at least 10 times longer than the device dimensions. There is an inverse relation with path length increasing as pressure decreases, so practical vacuum levels for micron-scale devices will be 0.1% of atmospheric pressure (1 millibar) or lower.

In some aspects, these devices may be manufactured with a vacuum in the active paths between cathode and anode, which is sealed inside a finished package or device. In other aspects, the device may be providing an electron source within a larger chamber or space, in which a vacuum matching the electron path length is maintained during operation. In some aspects, the choice of conductors and a suitably thin insulator between them may allow the flow of electrons to be modulated by changes of 5 volt or less, thus making the system compatible with direct control by Complementary Metal Oxide Silicon (CMOS) circuitry or similar control electronics. In some aspects, the first and second conductors may both be the same, for example both made of aluminum or chromium. In other aspects, the first and second conductors may be different, such as zirconium and tungsten, or aluminum and chromium, or n-doped silicon and p-doped silicon, or n-doped silicon and aluminum, or n-doped silicon and graphene, or n-doped silicon and chromium. In some aspects, the conductors may be supported by a substrate which supports the device and which supports the supply of voltage and current to the first conductor.

In some aspects, the supply of current and voltage to the second conductor may be provided separately from the substrate, for example by wired connections contacting the second conductor from outside of the substrate.

In some cases, the insulating layer between first and second conductors may be 10 nm of silicon dioxide, or 20 nm of zirconium oxide, or 15 nm of aluminum oxide, to name a few example implementations. The insulating layer should be as thin as possible so as to create strong charge accumulation on the adjacent conductors while remaining thick enough to avoid unwanted amounts of direct tunneling current through the insulator.

In some aspects, the first and second conductors and their intervening insulator may be layered flat on the substrate with etching or cleaving to create the edges where electrons may be emitted. In other aspects, the first conductor, insulator, and second conductor may be aligned vertically to the surface of the substrate with the surface prepared so as to cleanly expose their edges where electrons may be emitted. In some aspects, the supply of current and voltage to the second conductor may also be arranged through the substrate, for example by etching separate circuits and isolating insulator into the substrate and making contacts from these circuits to the second conductor separately from how current and voltage are connected to the first conductor.

In some aspects, the substrate may support integrated circuitry, such as circuits with CMOS elements, which control and possibly modulate the distinct voltage and current supplied to the first or second conductors, or to both of them. In some cases, additional structures for insulation and construction may be added beyond the second conductor, so that while it may act as a gate electrode to control the surface charge and rate of electron flow out of the first conductor (the cathode), the role of anode or eventual destination for most of the electrons may be performed by some other element. Such an example includes a third conductor placed at some short distance beyond the second conductor and at sufficient positive voltage to accelerate electrons past the gate electrode towards the new anode. With the correct distances and voltage difference, this new conductor may promote a higher current by clearing electrons from the vicinity of the cathode, reducing the space charge from those electrons, which can suppress current in the same way it does around thermionic cathodes in vacuum tubes.

In some aspects, additional beams may be present which terminate internally to the device to cause heating. It is also possible to use resistive elements to achieve heating. These beams or elements would be switched by patterns synchronized with the activation pattern of the beams so that when the beam is not selected, the heat it would have caused is matched by the internal beams or resistive devices. The goal with either of these heating systems is to ensure that the average power is constant and evenly applied across the device, regardless of the pattern projected on the target. The constant and uniform heating will improve dimensional stability of the grid. The additional elements do not need to be as numerous as the projected beams, and the modulation does not need to be as fast, as long as the average temperature is maintained uniformly enough to keep dimensional stability to the required accuracy.

In some aspects, the first conductor may incorporate an electrode membrane spanning the open space where electrons are emitted, where the membrane is of a thin material, such as a single layer of graphene, which is mostly transparent to low voltage electrons approaching from the edge emission areas, thus providing a gradient to promote charge clearance from the emission region. Electrons pass through the conductor membrane on their way to another region of the device which is at least as positive in charge as the first conductor. The use of this membrane increases field gradients to promote higher current flow from the edge zone. The membrane also provides a barrier to contaminants and helps maintain the low pressure or vacuum interior to the device.

In some aspects, the second conductor may incorporate an electrode membrane spanning the central region of the conductor. This membrane may be mostly transparent to low voltage electrons approaching from the side, thus providing a gradient to promote a stronger field gradient for increased current flow, while also blocking the entrance of contaminants and sealing in the low pressure or vacuum interior to the device. Electrons pass through the second conductor's membrane on their way to other parts of the device which include the eventual anode capturing the electrons. This second transparent conductor acts like the second electrode gate of a classic tetrode vacuum tube. Tetrode design enables the transparent electrode at low voltage to provide a very stable voltage gradient and current flow in a thin construction, independent of larger distances and large, variable voltages for the eventual anode.

The tetrode configuration can be used for high power high voltage switching when all sources are synchronized, instead of being operated as individually modulated elements in a pattern generator. The electron-transparent span of the second conductor ensures current flows efficiently even when the forward voltage at the anode falls to just a few volts, as is required for an efficient switch in the “on” state. The device may include a vacuum gap of millimeters or centimeters from the second conductor to the anode for purpose of withstanding high voltages when the device is off. When the device is on and the voltage difference is low, the electrons coast on a ballistic path to the anode after passing the second conductor.

Electron beam sources can be vulnerable to contamination from the target, which may rapidly spoil a source which is exposed to that contamination. This has been especially true for photocathodes and thermionic cathodes which use surface coatings such as cesium or barium which have low work functions, enabling lower voltages for electrons to reach vacuum, but which are chemically reactive as well as evanescent at ordinary working temperatures. Those surfaces poison rapidly in exposure to air or other contaminants, and they degrade within hours or tens of hours of use.

Other electron beam sources may use intense electric gradients at point sources to overcome the work function of more robust materials like tungsten. These needle points are admirably fine sources of electrons but need either voltages too high for integration with CMOS, or chemical coatings which have short operating lifetime. In practice, they have not proven the long lifetime, fast modulation, and low voltage operation scalable to millions of sources in a compact array, which are enabled together with the described systems and methods.

The new electron source, described herein, can be constructed with metals or semiconductors which have quite robust emission-edge surfaces, which can operate for hundreds of hours in air while showing negligible decline. In addition to this fundamental robustness, the use of electron-transparent spanning conductors, such as graphene, provides a barrier preventing contaminants from reaching the emission source. This results in substantial stable operating life.

The edge emission approach may be modulated from no current to full current with a change of less than 5 volts in the difference between cathode and gate (first and second conductors). The small voltage leads to electrons emitted with low energies and low variable energies, thus allowing better control of the electron trajectories when they are entered into low voltage devices.

In some aspects, the described systems and techniques innovate in multiple ways which combine to make short path systems practical. Short paths below a millimeter enable scaling up to millions of parallel beams. The beams have an extremely brief time of flight and thus minimize mutual interference. Short beams can run with high intensity and fast patterns. Short beams with only a few microns of distance to the target can be packed with microns of separation while still having lenses with a numerical aperture of 0.1 or higher, which allows nanometer scale of resolution even with electron energies under 100 electron-volts.

The described edge emitters can be constructed with source elements of 50 nm diameter or less which provide currents as large as tens of nano-amps and modulation times of a nanosecond or less. The current intensity supports rapid exposure of targets and the modulation rate enables detailed patterns to be generated at high speeds. The small size and direct integration with CMOS devices allows source modulators to be built at small size and low cost. This allows machines of modest size, each device manufactured to closely match all others. They can then be deployed in large numbers within a limited space on a production line.

In some aspects, the slight deviations from chip to chip will be measured and characterized after fabricating the electron beam and beam-channel assembly, so that the machine using the electron source modulator can adjust positioning, temperature, and other variables which result in a beam pattern which reliably and repeatably matches ideal dimensions and alignment. Projection machines can include periodic tests to monitor for wear or contamination and then allow worn devices to be swapped with new ones. Periodic pauses in production may be applied when the device is operated to generate test patterns used for monitoring device performance. The device may be designed for rapid swap and recalibration with the parameters of the new device.

In the preceding and following description, various techniques are described. For purposes of explanation, specific configurations and details are set forth to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

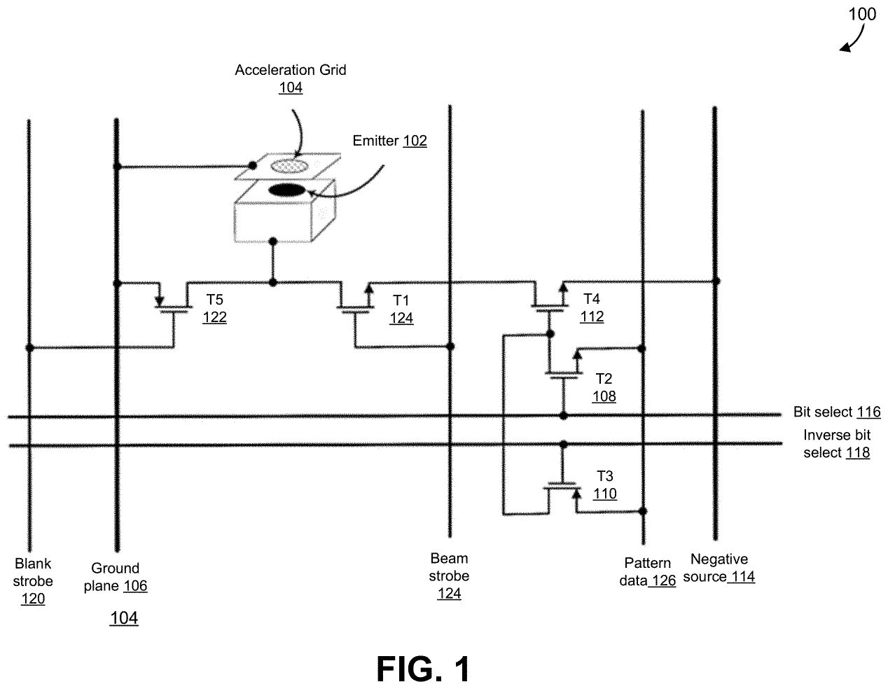

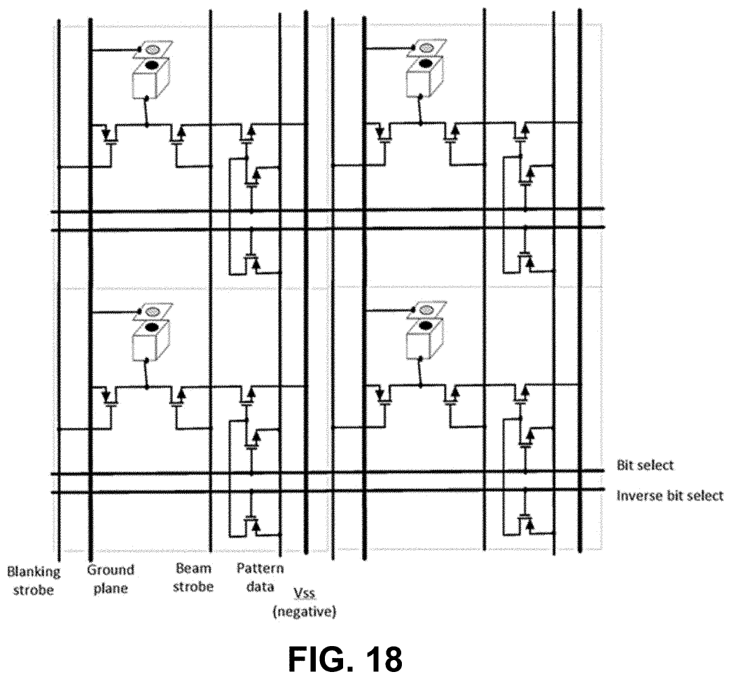

FIG. 1 illustrates an example circuit schematic 100 for electronic control of a single electron beam source, such as an electron beam source that uses the Fowler-Nordheim effect to emit electrons through the side wall of a well etched into a conductor under a dielectric. The example circuit 100 is one which can be fabricated in a planar CMOS process. The electrons will be emitted when the Emitter well 102 is held at a negative source voltage relative to the acceleration grid 104, which is connected to the ground plane 106. No electrons will be emitted when the Emitter well 102 is raised to match the ground plane voltage. The pattern data is connected via the T2/T3 pass gates 108, 110 to the gate of transistor T4 112, which enables or disables the flow of current from the negative source 114. The bit select and inverse bit select lines 116, 118 control the T2/T3 pass gates 108, 110 so that the timing of that gate is open when the pattern data 126 is intended for this electron source, and the pass gates are closed at other times when the pattern data 126 is intended for different sources. When the pass gates close, the voltage state of the pattern remains held for tens of microseconds on the gate of T4 112 due to its gate capacitance. As a result, if the bit selection frequency is at least 1 MHz, this will function to latch the pattern data 126. Most of the time the beam source is inactive, with the blanking strobe 120 enabled and T5 122 connecting the emitter 102 to the ground plane 106 so that no beam is generated. However, when all the pattern data 126 has been latched into the T4 gates 112 of all the sources, then the blanking strobe 120 is disabled and the beam strobe 124 is enabled, allowing the emitter 102 to connect through T1 124 to the output of T4 112. If T4 112 is in an enabled state due to the value held in the T4 gate capacitance, then current can flow from the negative source 114 and a beam is generated. If T4 112 is not enabled, then no connection occurs and no beam flows. In this way, when beam strobe 124 is active, the beam will flow according to the pattern data 126 that was sampled through the T2/T3 pass gates 108, 110. The beam strobe 124 is then disabled, the blanking strobe 120 is enabled to end any beam transmission by returning the emitter 102 to connection with the ground plane 106 through T5 122, and the source awaits the next pattern data which will be received when the bit selection is next enabled. As will be described in greater detail below in reference to FIG. 18, multiple of these circuits can be combined to control an electron beam emitter array of a large number of emitters.

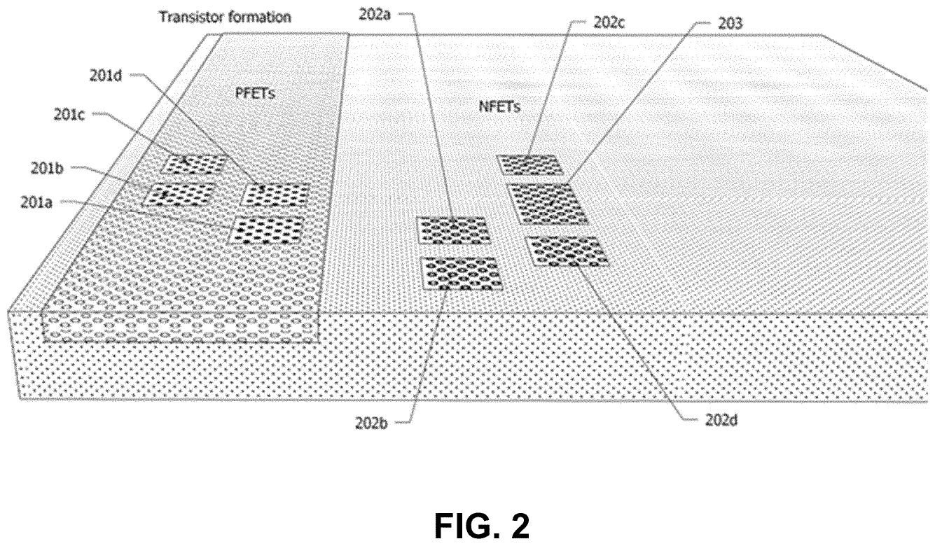

FIGS. 2-17 illustrate example steps or stages in a process for constructing an electron beam source, such as according to the circuit of FIG. 1, using a CMOS planar process. It should be appreciated that the physical circuits illustrated and described in reference to FIGS. 2-17 are only given by way of example, and that various modifications and alterations may be made to the circuit design, including location, size, and relative position of elements, to accomplish a similar functioning circuit.

FIG. 2 illustrates a first step in realizing or constructing a circuit of the type described above in reference to FIG. 1, using a CMOS planar process. In some aspects, the area of an emitter source cell will be relatively large, such as a few microns on each side. As a result, the process used may be a relatively older and simpler process, such as using a 130 nm planar CMOS, and still fit easily within the bounds of the source cell. However, it is possible that reasons of performance, power, voltage, or other functionality may cause a different process to be used, such other processes not using CMOS. Any circuit which modulates the emitter voltage to match the pattern data could be adapted and used in place of the planar CMOS process described herein.

In the example illustrated, using simplifications of steps which will be understood by those having ordinary skill in the design and fabrication of planar CMOS, the circuit begins with enhanced N-doped wells (201a, 201b, 201c, 201d) for the N+ source and drain areas of p-channel field-effect transistors (PFETs) to be formed in a P-doped substrate, while the enhanced P-doped wells for (202a, 202b, 202c, 202d) P+ source and drain implants in the N-doped substrate will become the n-channel field-effect transistors (NFETs).

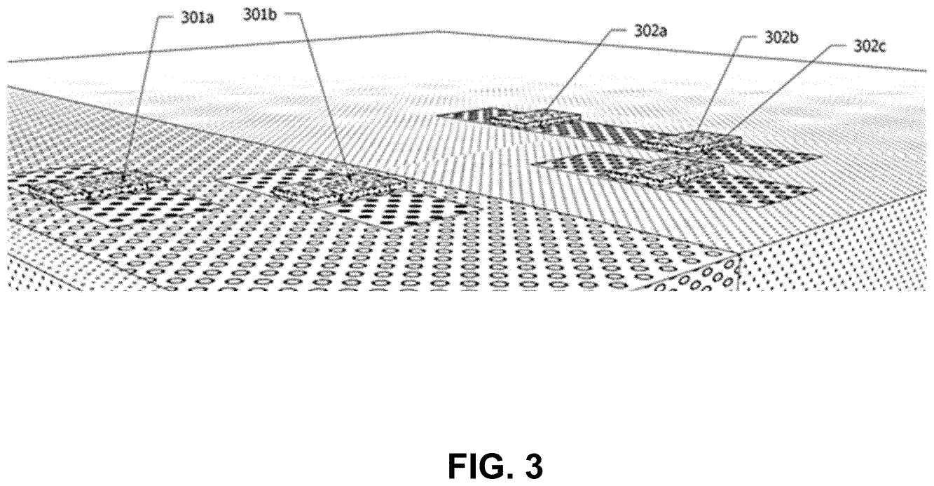

FIG. 3 illustrates PFET gates (301a, 301b) and NFET gates (302a, 302b, 302c) which control the transistor channels between the source and drain regions formed on top of or added to the wells (201a, 201b, 201c, 201d) and (202a, 202b, 202c, 202d), respectively, described above in reference to FIG. 2.

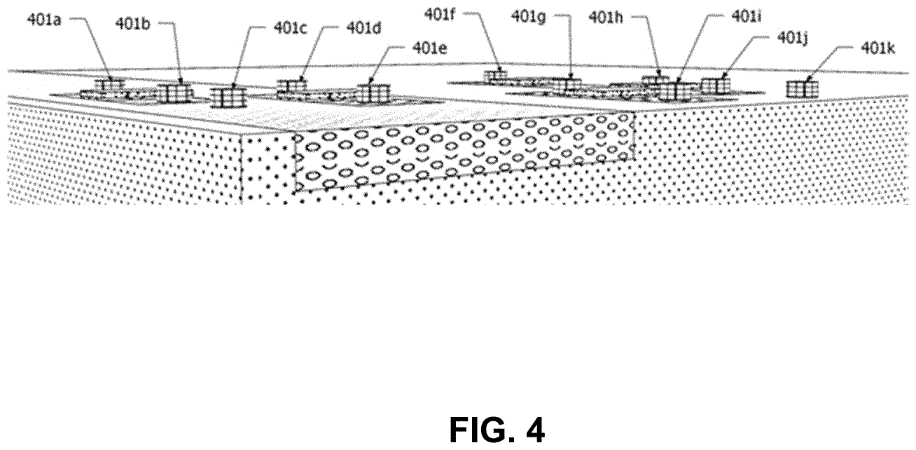

FIG. 4 illustrates vias (401a thru 401k) being added to (e.g., on top of or electrically connected to PFET gates (301a, 301b) and NFET gates (302a, 302b, 302c to allow connections up from the planar level to what will be the first level of metal. The bases of the vias touch upon the sources or drains of transistors (for example 401a and 401b), or the bulk substrate wells (401c, 401k). The illustration omits the insulating layer which covers the entire surface, for clarity and simplicity. The vias may be formed where holes are etched through the insulation.

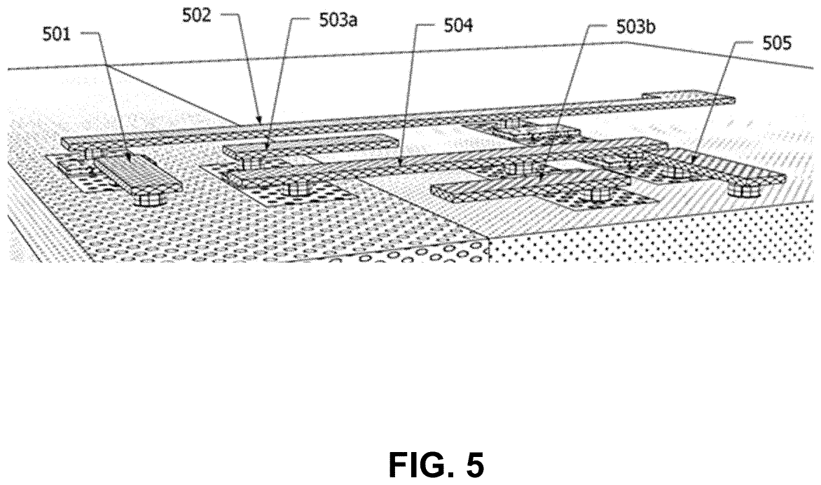

FIG. 5 illustrates an example of first level metal traces being added on top of the vias. A source-Vcc strap or structure (501) attaches the ground plane of the planar silicon through via 401b to transistor T5. The trace (502) will connect the outputs from T5 or T1 to the emitter source. Traces (503a, 503b) connect the pass transistors T3 and T2 to the pattern data. Trace (504) connects the output from pass transistors T2 and T3 to the gate of T4. Trace (505) brings the negative source to T4. T4 and T1 are connected by a shared well for the drain of T4 and the source of T1.

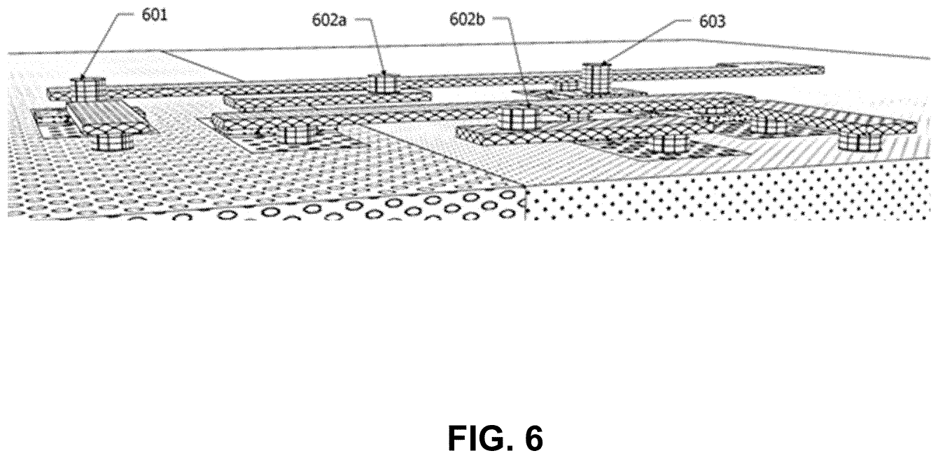

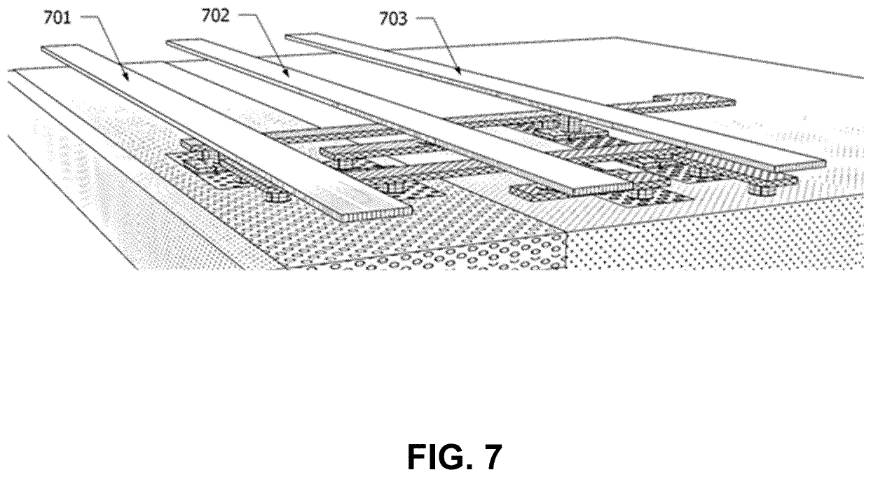

FIG. 6 illustrates vias (601, 603) connecting to gates while vias (602, 603) connect to the first level metal traces illustrated in FIG. 5. These vias will connect to a second metal. FIG. 7 illustrates a second metal blanking strobe structure (701), second metal data structure (702), second metal beam strobe structure (703) which connect to the top of the vias 601, 602a and 602b, and 603, respectively.

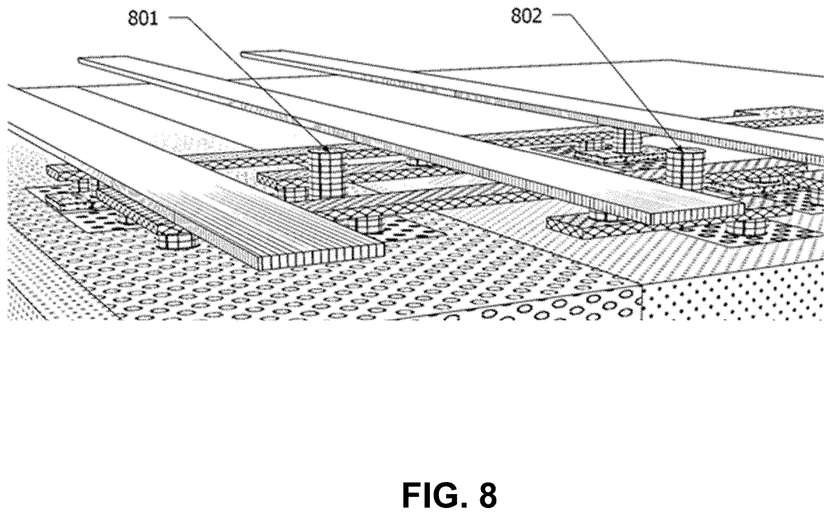

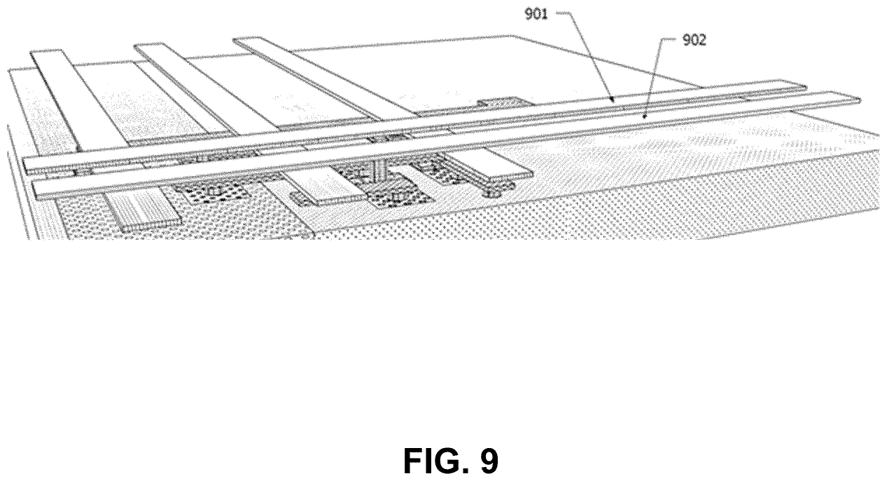

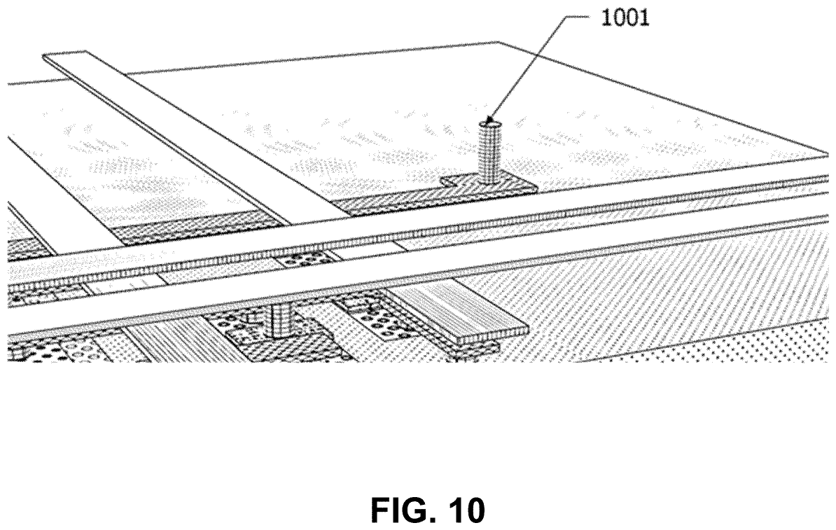

FIG. 8 illustrates an example a third level via (801) for inverse bit select, and a third level via (802) for bit select. FIG. 9 illustrates a third metal structure (901) for inverse word select, and a third metal structure (902) for word select. FIG. 10 illustrates an output via (1001) connecting the shared output metal for T1 and T5 , which controls the beam source current.

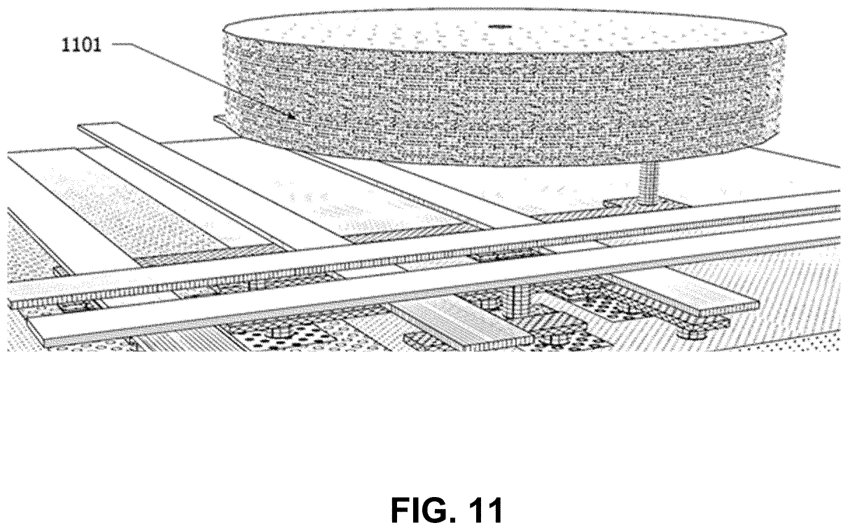

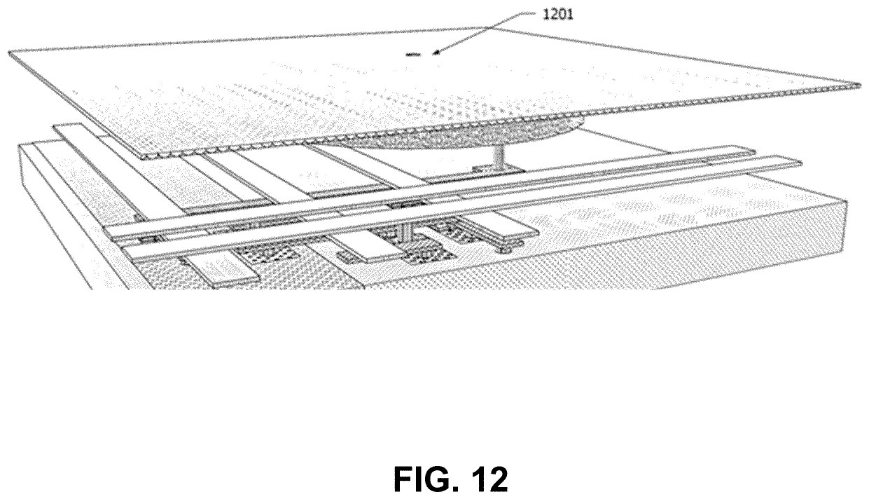

FIG. 11 illustrates an emitter conductor source layer (1101) added to the structure of FIG. 10, which may be shaped as a disk connected to the output via (1001). FIG. 12 illustrates an emission dielectric layer (1201) that uniformly coats the surface of the device, including coverage over the source layer (1101), with a hole aligned with the well in the source layer where the electron beam originates.

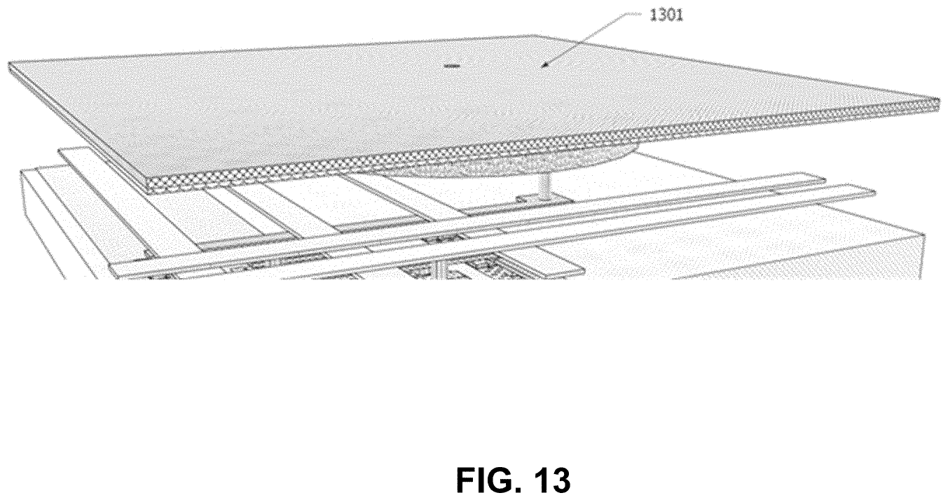

FIG. 13 illustrates an emission attractor conductor layer (1301), acting as a Vdd plane for the device, incorporating a well which aligns and connects to the well in the emission source. The electron beam shall exit this well when the emitter source is sufficiently negative relative to the attractor conductor. This provides the voltage positive with respect to the emitter source (1201), which sets up the intense gradient through the dielectric (1201) causing the field effect at the interface between source emitter and dielectric which promotes emission from the edge of the well. The choice of the materials for the attractor conductor (1301) and the emitter conductor (1101) by their relative properties such as band gap and surface electron affinity also have an effect, where the proper selection may bias the source to emit at lower voltages due to changes in the surface affinity due to the nearby attractor conductor.

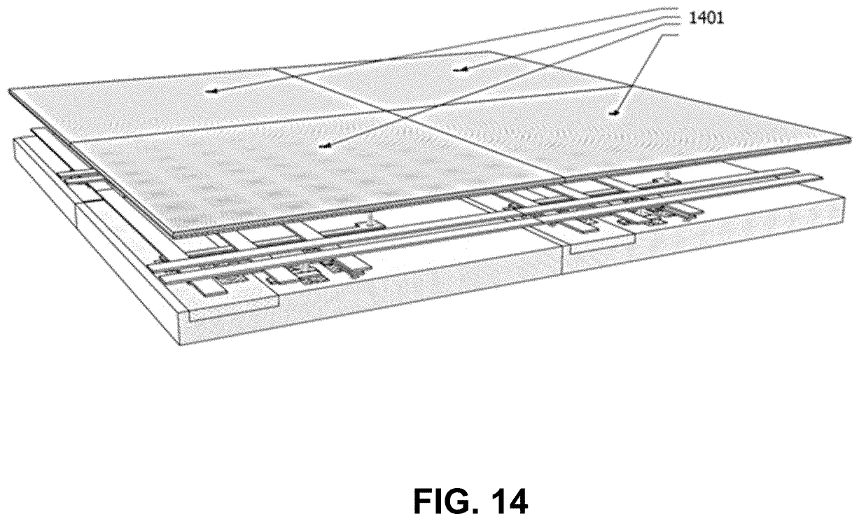

FIG. 14 illustrates an example pixel array (1401) of multiple emission cells arranged adjacently to cover the top plane of the device with multiple modulated beam sources.

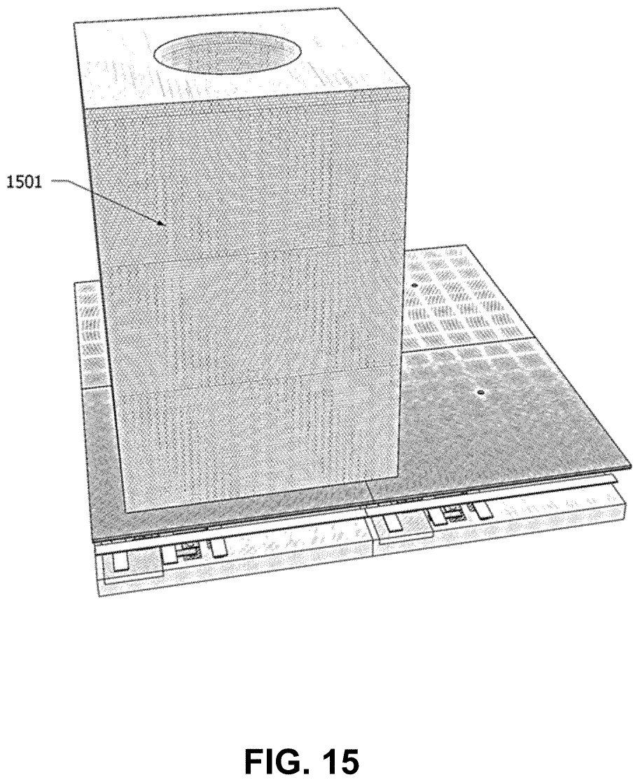

FIG. 15 illustrates an example beam channel (1501) which is constructed upon or joined upon the device surface, aligned with the beam emitting well on its central axis. This column may include a pellicle allowing electrons to pass, an aperture defining the shape of the beam image to be projected on the target, and elements of the electron optics.

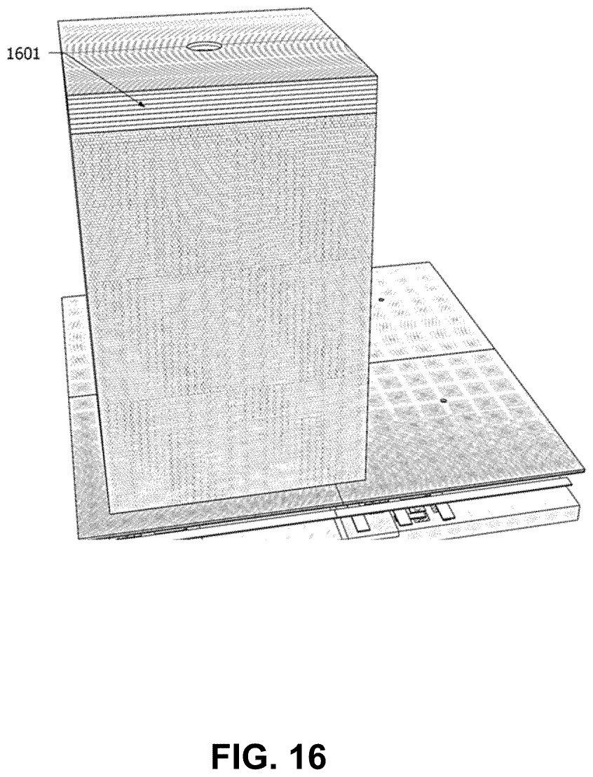

FIG. 16 illustrates an example beam output electron lens (1601) bringing the beam in the channel to convergence at a plane beyond the exit from the channel (1501). The lens assembly may end with a cap with a narrowed aperture which limits the entrance available to contaminants.

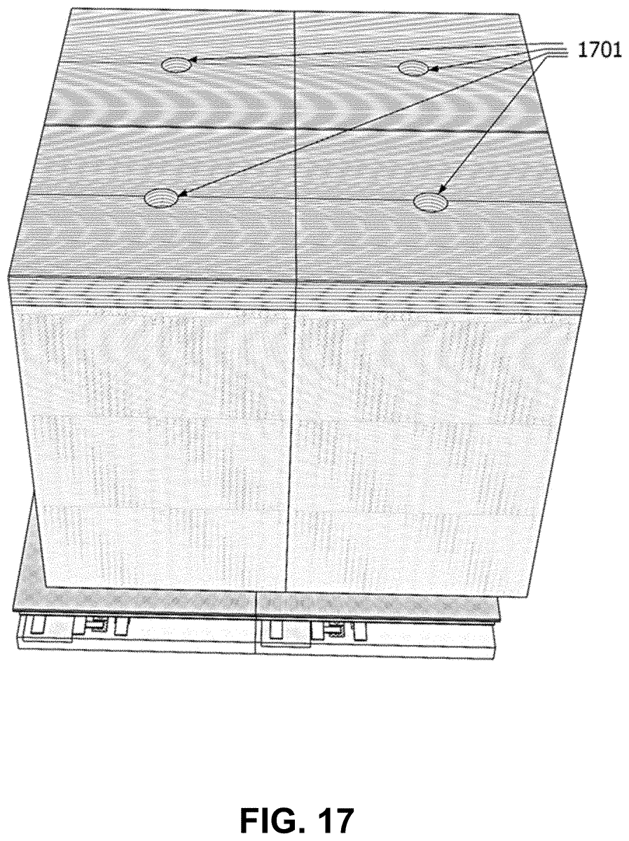

FIG. 17 illustrates an example array of beam outputs (1701) resulting from the beam channels organized as a contiguous array aligned with the beam emitting well array (1401).

FIG. 18 illustrates another example circuit schematic including multiple beam sources and indicating how the control lines for selection, strobes, and pattern data may connect at cell edges to link them as control lines which will continue to the edge of the array where they may connect to external control circuitry. The strobe is used to ensure multiple elements in an array flash briefly in synchronization to minimize blur on a target which may be moved steadily sideways across the image plane to form a raster pattern coverage of the entire target. A slightly tilted array may be used to ensure every beam traces one row of a raster pattern which eventually comprises the entire area of the target, where each beam may flash millions of times as it traces the row so that each flash, on or off or some analog level between, defines the state of a pixel in the target image.

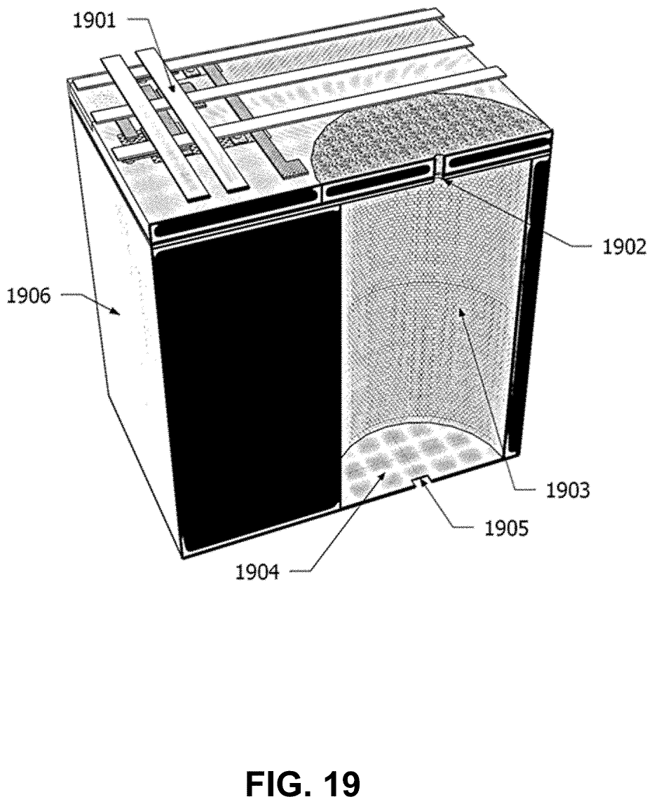

FIG. 19 illustrates an unfocused projector which uses a final aperture (1905) to shape the exit beam which will illuminate a target in proximity to the exit, in cutaway view. In the example of FIG. 19, beams may also exit through the underside of the substrate. The control circuit (1901) controls the electron emission well (1902) which dispenses electrons into the beam channel (1903) where they are accelerated towards an exit anode (1904) which is more positive than the emission well. The shaped aperture (1905) in the exit anode permits just that subset of electrons to pass which fit within the shape. The channel is formed within a supporting structure (1906).

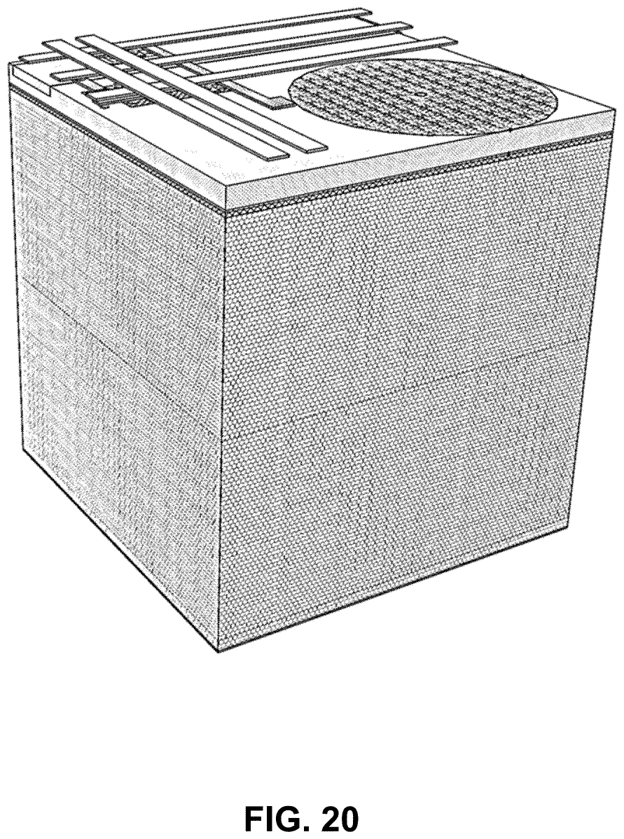

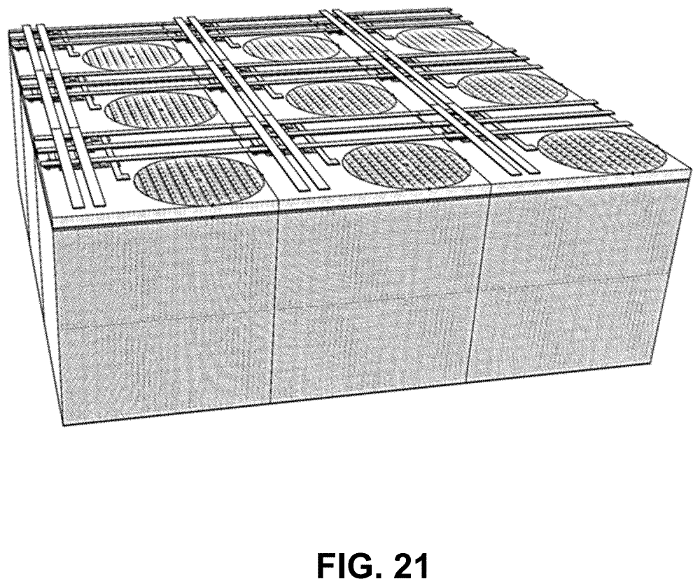

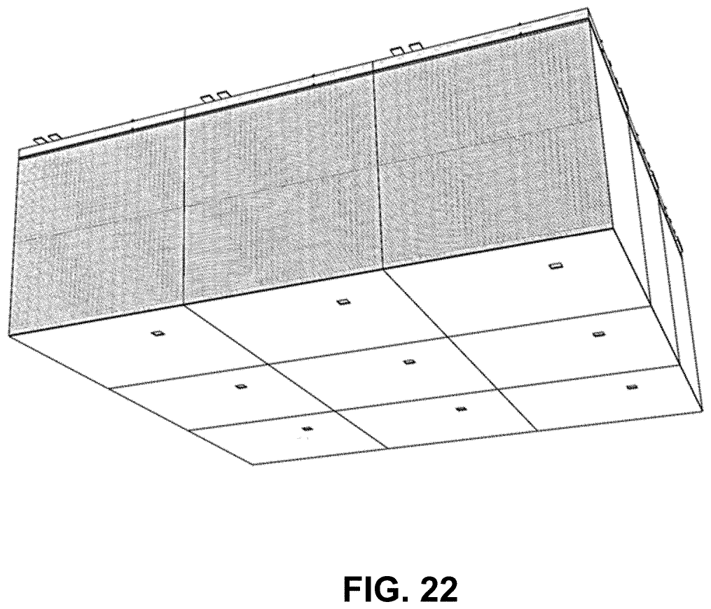

FIG. 20 shows the same cell illustrated in FIG. 19, of that same unfocused projector, without the cutaway. FIG. 21 show how multiple cells (e.g., the type illustrated in FIGS. 19 and 20), may be constructed adjacently to provide an array of electron emission units with connected control circuits. FIG. 22 shows a set of adjacent proximity projection cells as seen from the side where the beams exit, with the exit apertures carefully aligned to form an array of shaped beams.

### SYSTEM OVERVIEW

The systems and techniques described herein may enable sustained production of multiple beams of electrons which may be individually modulated, such as at high speed and high current density. In some aspects, the described systems and techniques may utilize a planar semiconductor substrate in which data streams through circuits such that 1 and 0 values cause transistors to switch which vary the voltage at the electron source so as to suppress or enable the electron emission from the source. These modulated electrons then enter into low pressure or vacuum spaces containing structures with voltage and magnetic fields which accelerate and guide the electrons to useful purposes.

The circuit for a source element may include a selection gate to sample the data stream at the correct time, a latch circuit to hold the value until it is time to use it, an enable gate which connects the value to modulate the source for the fraction of time when the electrons should fly, and a current gate to connect the source to a power and current source when the value enables current to flow. For higher data rates, the circuit may include two data latches so that one may be used to drive the electron source while the other is used to capture the next value from the data stream. This allows data streaming and electron emission to be simultaneous. The interval needed for the value to be transferred from the next-value latch to the current-value latch can be a very brief fraction of the element modulation interval.

It is also possible to have a circuit containing substantially the same elements of gates and latches, but for the value output to control the voltage at the first conductor rather than the voltage of the electron source conductive substrate. The electron emission is enabled when these voltages are different and suppressed when they are the same. Therefore modulating the first conductor acts as a gate to switch off the current. The advantage to this arrangement is that very little current flows through the first conductor, typically less than a tenth of the total electron flow will go to that conductor, and thus the modulation transistors do not need to carry as much current.

In some aspects, the circuits built on the semiconductor surface will be underneath the emission surfaces, which are constructed on top. This eliminates interference between the emitted electrons and the top-level wiring of the circuits. When the circuits are complete they may be sealed and planarized in the normal manner, with contacts from the circuits exposed at the top where they will connect with the corresponding emitters. The emitters are deposited on top and aligned to meet the contacts. The emitters are built up in layers of alternating conductor and insulator of the appropriate material and thickness, with etching used to create the cavities where electron emission will occur.

There may be further structures built above the emitters to guide, shape, and use the electron beams which are emerging from the emitters. There are many applications for modulated electron beams, so these structures will be various. These structures may be aligned to individual beam sources or they may have a larger scale control of spacing and electric fields in the regions above the device where the beams will be active.

In some aspects, the beam may pass through an aperture which constrains the original spread of the beam to pass only a shaped subset, such as a square, round, rectangular, or other useful geometry deemed more effective and perhaps more compact than can be achieved with the original untrimmed beam. In some aspects, these apertures may be placed at relatively low voltage, between 1 and 20 volts positive relative to the source, allowing the use of a thin membrane such as a graphene monolayer to be stretched across the aperture, where the membrane is chosen to allow most electrons to pass through undisturbed. Such membranes may isolate the electron sources from contaminants, and may also flatten the electric fields near the aperture which can improve the guidance and focus of the electrons. The heat generated when stray electrons from active beams are absorbed around the apertures or elsewhere in the channel may be balanced and averaged out by other heating elements nearby which are modulated with complementary power to keep average heating constant.

In some aspects, a broad surface of the device may be switched in unison, permitting high emitter device currents to be switched on and off between the modulated source cathode and a relatively distant anode with vacuum between. Devices with this construction may resist very high voltages or ultra-high voltage in their off-state as the vacuum cannot sustain a current if no electrons are being sourced. When the electrode emission is enabled the drop from anode to cathode may fall to almost zero while the electrons coast from cathode to anode so long as that gradient remains positive, allowing efficient on-state operation when the load has much higher impedance than the vacuum beams.

In some aspect, the described system and techniques may include one or more of the above-described features. It should be appreciated that various combinations of these features are contemplated herein, and that language indicating inclusion of a combination of features is not a requirement that those features operation in combination to provide one or more advantages as described herein.

A modulated electron emitter array, as described herein, may include the following features, where each emission comes from the open edge of a conductor at an edge adjacent to an insulator which sets up an intense electric gradient such that the boundary of the conductor at the insulator is crowded with electrons attracted to the gradient, causing sideways Fowler-Nordheim electron emission at the exposed edges of that layer, where the edge is arranged to be a well or channel cutting through the insulator and into the conductor, with an electric field from elements at the opposite side of the insulator from the conductor arranged to attract those electrons to form a beam away from the conductor into a void, The emitter may be one of many in an array integrated above a CMOS or other kind of control chip, where signals from the chip are attached to control the voltages applied across the insulator so that the electric gradient may be applied or may be removed, so that the beams are flowing or stopped. Each beam may be modulated independently and the electron beams flow into destinations on devices which may be separate from the source device with voltage potential and alignment arranged to attract and utilize the electron beams. The beams shall be in a vacuum of less than 10 millibar pressure to ensure a mean free path of 5 microns or longer to allow interactions with apparatus distinct from the chip and emission sources.

The modulated electron emitter array described above, flowing to a pierced conductor plane which has a positive voltage relative to the beam source device, where the conductor plane is pierced by apertures aligned with the beams, where these apertures are smaller than the width of the beams as each arrives at the plane, and the apertures are shaped to form geometrical elements such as squares or circles, so that the subset of the electrons which pass through the aperture will continue as a secondary beam which has the shape defined by the aperture.

The modulated electron emitter array described above, where an array of electron-optic channels is aligned with the beams at a set of voltages relative to the emitter array such that the electrons are accelerated through the column and focused by the column, with a focal plane beyond the end of each column at a place where electrons may impinge upon a target.

The modulated electron emitter array described above, combined with the array of electron-optic channels such that the apertures of the pierced array are at the source focus of the channels to pass their secondary electron beam into the channel so that the image focused upon the target will take the same geometrical shape as the aperture.

The modulated electron emitter array described above, combined with an electron-transparent pellicle such as a graphene sheet which allows the electrons to pass while isolating the emitter source from molecular contamination in the rest of the chamber where the device is in use.

The modulated electron emitter array described above, combined with an electron-transparent pellicle such as a graphene sheet which allows the electrons to pass while isolating the emitter source from molecular contamination in the rest of the chamber where the device is in use, and which also flattens the electron gradient in the region of the aperture to minimize unwanted lensing which blur the image of the aperture.

The modulated electron emitter array described above, combined with shaped surfaces surrounding each aperture designed to flatten the electric gradients at the entry and exit from the apertures to minimize unwanted lensing that may blur the image of the aperture.

The modulated electron emitter array described above, combined with a CMOS circuit allowing pattern data to be loaded into a latch per cell while the cell is isolated from the beam channel and the voltages reset so the beam is off, and then a strobe signal is applied to a plurality of cells in parallel to allow the pattern to be applied to their beams, allowing the pattern to be expressed in a brief synchronized burst of simultaneous beams to minimize blur on a moving target.

In another example, an electron beam source may include an array of electron-optic channels, where the beams aligned with the center of each channel with electrons flowing from a source each using low-voltage emission from a well which induces electron emission from the sides of the well at a junction edge where a conductor plane and an insulator plane with a steep electric field gradient meet at the wall of the well, the electrons flowing out of the well towards the central axis of the electron-optic channel due to a net positive potential gradient from the well toward that axis.

The electron beam source described above, with CMOS or other circuit on the substrate upon which the emission wells are arrayed where the circuit controls the voltages applied to each well so that the field gradient across the insulator at the emission-conductor boundary may be varied, such that the strength of the gradient alters the rate of flow of the electrons from the edge into the well.

The electron beam source described above, with one or more memory bits per beam emitter built into the control circuit and a mechanism where each cell may be activated, whether on or off, at a current strength according to the data in the memory for that beam, only when a strobe signal is delivered to that cell, such that all the beams connected to that same strobe signal will flash their beam pattern simultaneously.

The electron beam source described above, where a perforated conductor plane is included within the system such that the perforations are aligned with the axis of each channel at the source focus of the electron optics in each channel, where the perforation is an aperture of a desired geometric shape such as a square, circle, or square with rounded corners, limiting passage of electrons from the source to only those which fit the shape of the aperture, so that the electron optics will project the image of that geometric shape upon the target plane beyond the outlet from the beam channel.

The electron beam source described above, combined with varied surface shape around each aperture designed to flatten the electric gradient at the entrance and exit of the aperture so as to minimize the blur in imaging the aperture by the electron-optical channel.

The electron beam source described above, with an external system which feeds new data patterns to the pattern data on the chip in the time between strobes, so that a much larger external memory may be used to arrange for every flash of the beams to be part of an overall image requiring potentially millions of different data values to be flashed by each and every beam in the array. This allows a large area target to be completely drawn with trillions of pattern cells using just millions of beams, for example by linear movement of the target across the face of the beam system creating an area-filling raster pattern.

Other variations are within the spirit of the present disclosure. Thus, while the disclosed techniques are susceptible to various modifications and alternative constructions, certain illustrated embodiments thereof are shown in the drawings and have been described above in detail. It should be understood however, that there is no intention to limit scope of this disclosure to the specific form or forms disclosed but, on the contrary, the intention is to cover all modifications, alternative constructions, and equivalents falling within the spirit and scope of the described systems and methods, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Similarly, use of the term “or” is to be construed to mean “and/or” unless contradicted explicitly or by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood within the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context. In addition, unless otherwise noted or contradicted by context, the term “plurality” indicates a state of being plural (e.g., “a plurality of items” indicates multiple items). The number of items in a plurality is at least two but can be more when so indicated either explicitly or by context.

Operations of processes described herein can be performed in any suitable order unless otherwise indicated herein or otherwise clearly contradicted by context. In an embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In an embodiment, the code is stored on a computer-readable storage medium, for example, in the form of a computer program comprising a plurality of instructions executable by one or more processors. In an embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In an embodiment, code (e.g., executable code or source code) is stored on a set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media, in an embodiment, comprises multiple non-transitory computer-readable storage media, and one or more of individual non-transitory storage media of the multiple non-transitory computer-readable storage media lack all of the code while the multiple non-transitory computer-readable storage media collectively store all of the code. In an embodiment, the executable instructions are executed such that different instructions are executed by different processors—for example, in an embodiment, a non-transitory computer-readable storage medium stores instructions and a main CPU executes some of the instructions while a graphics processor unit executes other instructions. In another embodiment, different components of a computer system have separate processors and different processors execute different subsets of the instructions.

Accordingly, in an embodiment, computer systems are configured to implement one or more services that singly or collectively perform operations of processes described herein, and such computer systems are configured with applicable hardware and/or software that enable the performance of the operations. Further, a computer system, in an embodiment of the present disclosure, is a single device and, in another embodiment, is a distributed computer system comprising multiple devices that operate differently such that the distributed computer system performs the operations described herein and such that a single device does not perform all operations.

The use of any and all examples or exemplary language (e.g., “such as”) provided herein is intended merely to better illuminate embodiments of the disclosure and does not pose a limitation on the scope of the disclosure unless otherwise claimed. No language in the specification should be construed as indicating any non-claimed element as essential to the practice of the described systems and methods.

Embodiments of this disclosure are described herein, including the best mode known to the inventors. Variations of those embodiments may become apparent to those of ordinary skill in the art upon reading the foregoing description. The inventors expect skilled artisans to employ such variations as appropriate, and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references including publications, patent applications, and patents cited herein are hereby incorporated by reference to the same extent as if each reference were individually and specifically indicated to be incorporated by reference and were set forth in its entirety herein.

What is claimed is:

1. An electron emitter array comprising:
a plurality of electron emitters, wherein individual electron emitters of the plurality of electron emitters comprise:
a first conductor having a conductor edge;
an insulator adjacent to the first conductor, and
a second conductor adjacent to the insulator, wherein the first conductor, the insulator, and the second conductor form a channel such that an electric field from the second conductor at the opposite side of the insulator from the first conductor attracts electrons to form an electron beam via Fowler-Nordheim electron emission directed away from the conductor edge of the first conductor through the channel past the second conductor into a vacuum chamber beyond the second conductor; and
control circuity in communication with individual electron of the plurality of electron emitters, wherein the plurality of electron emitters are formed on the control circuity, and wherein the control circuitry directs voltages to be applied across individual insulators of individual electron emitters so an electric gradient is applied, thus activating the individual electron emitters to form a pattern beyond the vacuum chamber, wherein, upon exposure to a target, the pattern is formed on the target.

2. The electron emitter array of claim 1, further comprising a conductor plane spaced apart from the second conductor and forming a plurality of apertures aligned with channels of the individual electron emitters, wherein individual apertures of the plurality of apertures form shapes that modify the pattern.

3. The electron emitter array of claim 2, wherein the conductor plane has a positive voltage relative to the second conductor.

4. The electron emitter array of claim 2, wherein a size of the individual apertures is smaller than beams formed from individual channels of individual electron emitters of the plurality of electron emitters.

5. The electron emitter array of claim 1, further comprising an array of electron-optic channels aligned with individual channels formed by the plurality of electron emitters, wherein as voltage is applied to the array of electron-optic channels, electrons are accelerated through the array of electron-optic channels to form the pattern on the target.

6. The electron emitter array of claim 2, further comprising an array of electron-optic channels aligned with individual apertures of the plurality of apertures of the conductor plane, wherein as voltage is applied to the array of electron-optic channels, electrons are accelerated through the array of electron-optic channels to form the pattern on the target.

7. The electron emitter array of claim 1, further comprising an electron-transparent pellicle proximate to the second conductor of individual electron emitters of the plurality of electron emitters that allows electrons to pass while isolating the of individual electron emitters from molecular contamination.

8. The electron emitter array of claim 2, further comprising an electron-transparent pellicle proximate to at least one of the second conductor of individual electron emitters of the plurality of electron emitters or the conductor plane that allows electrons to pass while isolating the of individual electron emitters from molecular contamination, wherein electron-transparent pellicle flattens the electron gradient proximate to individual apertures of the plurality of apertures to reduce lensing effects.

9. The electron emitter array of claim 2, further comprising at least one shaped surface surrounding individual apertures of the plurality of apertures designed to flatten the electric gradients at the entry and exit from the individual apertures to minimize lensing effects.

10. The electron emitter array of claim 1, wherein the control circuity comprises complementary metal oxide silicon (CMOS) devices including a plurality of transistors each operating as a latch for individual electron emitters of the plurality of electron emitters, wherein upon application of a first signal, a value is stored in individual transistors of the plurality of transistors, and wherein upon application of a second signal, the value from the induvial transistors forms the pattern.

11. The electron emitter array of claim 10, wherein the first signal comprises a signal applied through a bit select line or an inverse bit select line communicatively coupled with an individual transistor of the plurality of transistors, and wherein the second signal is applied simultaneously to the plurality of electron emitters to form the pattern.

12. The electron emitter array of claim 1, wherein at least a subset of the plurality of electron emitters terminate within the electron emitter array, and wherein the subset of electron emitters are activated in conjunction with other electron emitters of the plurality of electron emitters to provide substantially unform heating across the electron emitter array.

13. An electron emitter array comprising:
a plurality of electron emitters, wherein individual electron emitters of the plurality of electron emitters comprise: colleague
a voltage source;
a conductor plane in communication with the voltage source; and
an insulator proximate to the conductor plane, wherein the conductor plane and the insulator form a well having a wall, such that when the voltage source is activated, an electric field gradient is formed on the wall and produces a flow of electrons out of the well; and
an array of electron-optic channels, wherein individual electron-optic channels of the array of electron-optic channels are positioned on and aligned with individual electron emitters of the plurality of electron emitters such that the flow of electrons is directed through the individual electron-optic channels due to a net positive potential gradient from the well towards the individual electron-optic channels through a cavity forming free space between the individual insulators and the array of electron-optic channels to form a pattern proximate to an exit of the array of electron-optic channels.

14. The electron emitter array of claim 13, wherein the plurality of electron emitters are formed on a substrate, the electron emitter array further comprising:
control circuitry on or proximate to the substrate, wherein the control circuitry is configured to apply a voltage to individual wells of the individual electron emitters such that the electric field gradient on the wall is varied to affect a rate of the flow of electrons out of the well.

15. The electron emitter array of claim 14, wherein the control circuitry further comprises:
at least one memory bit per individual electron emitter; and
a strobe line communicatively connected to the at least one memory bit of each of the plurality of electron emitters, wherein when a strobe signal is applied to the strobe line, the plurality of electron emitters form the pattern according to the at least one memory bit in each of the plurality of electron emitters.

16. The electron emitter array of claim 13, further comprising a second conductor plane forming a number of perforations aligned with individual electron emitters of the plurality of electron emitters, wherein the number of perforations define the pattern that is formed proximate to the exit of the array of electron-optic channels.

17. The electron emitter array of claim 16, wherein individual perforations of the number of the perforations comprise an aperture defining an opening comprising one of a circle, square, or square with rounded corners.

18. The electron emitter array of claim 17, further comprising at least one varied surface shape around each aperture designed to flatten the electric gradient at an entrance and exit of the aperture so as to reduce blur in imaging the aperture by the electron-optical channel.

19. The electron emitter array of claim 15, further comprising a second memory system communicatively coupled to the control circuitry, wherein the second memory system is accessed via the strobe line to increase the rate of pattern generation of the electron emitter array.

20. The electron emitter array of claim 13, wherein at least a subset of the plurality of electron emitters terminate within the electron emitter array, and wherein the subset of electron emitters are activated in conjunction with other electron emitters of the plurality of electron emitters to provide substantially unform heating across at least a portion of the electron emitter array.
